(19) United States
(12) Patent Application Publication
(10) Pub. No.: US 2016/0165238 A1
(43) Pub. Date: Jun. 9, 2016

(54) NEIGHBOR TILE BUFFERING FOR DEBLOCK FILTERING ACROSS TILE BOUNDARIES

(71) Applicant: ViXS Systems Inc., Toronto (CA)

(72) Inventors: Wendy Wai Yin Cheung, Markham (CA); Xin Guo, Toronto (CA)

(21) Appl. No.: 14/564,226

(22) Filed: Dec. 9, 2014

(51) Int. Cl. H04N 19/176; H04N 19/86

(52) U.S. Cl. CPC H04N 19/176; H04N 19/86

(57) ABSTRACT

Deblock filtering at the tile boundaries of a tiled picture use a tile neighbor buffer in addition to top neighbor buffer left neighbor buffers. The tile neighbor buffer buffers pixel data from the bottom right corner of the left-diagonal tile. When the top rows of pixels of a tile are being filtered, the top neighbor buffer stores the bottom rows of pixels of the tile above. As the tiles are processed in raster order, some of the pixels in the top neighbor buffer are the pixels in the bottom right corner of the left-diagonal tile of the next tile to be filtered. The portion of the top neighbor buffer storing pixel data representing this bottom right corner is copied directly from the top neighbor buffer to the tile neighbor buffer for further filtering when processing the next tile.

### FIELD OF THE DISCLOSURE

The present disclosure generally relates to video processing and more particularly to deblock filtering.

### BACKGROUND

Deblocking filters are frequently used in various video encoding/decoding standards as either an in-loop filter or a post-processing filter to improve picture quality and increase coding efficiency by removing the blocking artifacts introduced by the block-based encoding of a picture. For the Advanced Video Coding (AVC) and VC-1 (SMPTE 421M) standards, the deblocking process is performed across the entire picture on a macroblock-by-macroblock basis in raster scan order. However, more recent video standards, such as the H.265/High Efficiency Video Coding (HEVC) standard, provide for each picture to be partitioned into tiles, whereby the encoding and decoding processes do not cross tile boundaries, with the exception of deblock filtering and certain other in-loop filtering processes.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a media system utilizing tile-based deblock filtering using a tile neighbor buffer in accordance with at least one embodiment of the present disclosure.

FIG. 2 is a flow diagram illustrating an example deblocking filter process using a tile neighbor buffer in accordance with at least one embodiment of the present disclosure.

FIG. 3 is a diagram illustrating an example tiled picture and an example buffer preparation process for deblock filtering of a tile at a left border of the picture in accordance with at least one embodiment of the present disclosure.

FIG. 4 is a diagram illustrating an example buffer preparation process for deblock filtering of an interior tile of the picture in accordance with at least one embodiment of the present disclosure.

FIGS. 5 and 6 are diagrams that together illustrate an example tile boundary deblock filtering process using the example of FIG. 4 in accordance with at least one embodiment of the present disclosure.

### DETAILED DESCRIPTION

The deblocking filter of a video decoder typically applies horizontal and vertical filters to smooth out discontinuities across block boundaries in a picture. For previous video coding standards such as Advanced Video Coding (AVC) (also known as the H.264 standard) and VC1 (more formally known as the SMPTE 421M standard), the deblocking filter processes macroblocks in raster scan order, and some partially filtered data is buffered in a top neighbor buffer and a left neighbor buffer for use in filtering the next set of pixels within the picture. The top neighbor buffer stores rows of the picture that are used for filtering the next row and the left neighbor buffer stores columns of the picture that are used for filtering the next column. The top and left neighbor data may be further modified in this filtering process.

However, with the advent of the High Efficiency Video Coding (HEVC) standard (also known as the H.265 standard), a picture may be partitioned into tiles for encoding purposes and decoding purposes. For each component, each tile is an array of what is referred to by the HEVC standard as a Coding Tree Block (CTB). Deblock filtering of the CTBs typically is performed in raster scan order within each tile, but raster scan order is not maintained for the overall picture. Aside from top neighbor and left neighbor buffering, additional buffering is needed to handle filtering that occurs across tile boundaries.

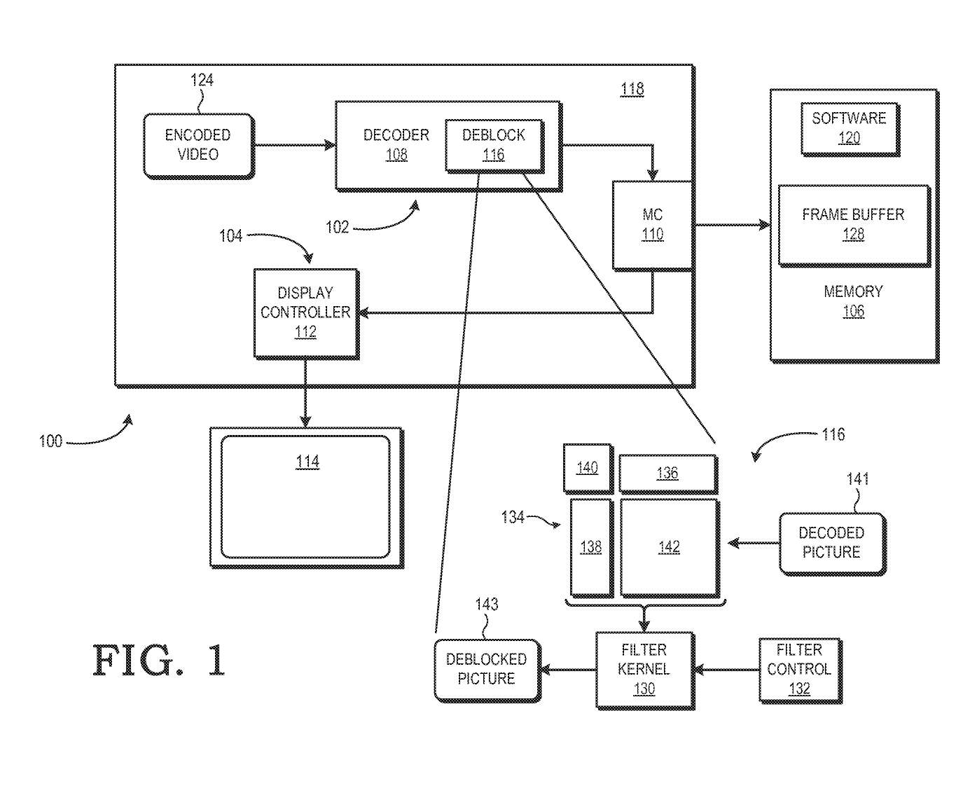

FIGS. 1-6 illustrate example techniques for deblock filtering at the tile boundaries of a tiled picture using a “tile neighbor buffer” in addition to a top neighbor buffer and a left neighbor buffer. The tile neighbor buffer is used to buffer the pixel data from the bottom right corner of the tile that is diagonally adjacent to the upper left of the tile selected for deblock filter processing (this diagonally-adjacent tile being referred to herein as the “left-diagonal tile”). When the top rows of pixels of a tile (e.g., the top row of CTBs in a tile) are being filtered, the top neighbor buffer stores the bottom rows of pixels of the tile above (e.g., part of the bottom row of CTBs in the tile above). As the tiles are processed in raster order, some of the pixels in the top neighbor buffer at this point are the pixels in the bottom right corner of the left-diagonal tile of the next tile to be filtered. As such, in at least one embodiment, the portion of the top neighbor buffer that stores the pixel data representing this bottom right corner is copied directly from the top neighbor buffer to the tile neighbor buffer for further filtering when processing the next tile. This data transfer is done before processing the next CTB row of the tile currently being filtered, so that the top neighbor buffer can be overwritten as deblock filtering moves down the rows of CTBs in the tile as part of the internal deblock filtering of the tile.

With this approach, the tile neighbor buffer can be sized according to the number of taps used in the filtering process, while being independent of (that is, the buffer does not scale with) the picture size, tile size, or number of tiles in a picture. As such, effective deblock filtering at tile boundaries may be implemented with a relatively compact tile neighbor buffer that need not be sized according to worst-case picture size or tile size scenarios, thereby minimizing memory resource requirements to implement. Moreover, direct transfer of the portion representing the bottom corner of the left-diagonal tile from the top neighbor buffer to the tile neighbor buffer can permit the bottom corner data to be readily available with minimal memory access effort.

For ease of illustration, the techniques of the present disclosure are described in the example context of H.265/HEVC-based decoding. Further, in this example context, a set of one or more rows of pixels of a tile stored in neighbor buffers is assumed to represent a row of CTBs of a tile, and a set of one or more columns of pixels stored in neighbor buffers is assumed to represent a column of CTBs of a tile. However, these techniques are not limited to this example context, and instead may be employed in any of a variety of tile-based encoding/decoding systems using the guidelines provided herein.

FIG. 1 illustrates an example media system 100 implementing deblock filtering in accordance with at least one embodiment of the present disclosure. The media system 100 includes a video processing system 102, a display system 104, and a memory 106. The video processing system 102 comprises a decoder 108 and a memory controller 110. The display system 104 includes a display controller 112 coupleable to a display 114. The decoder 108 includes a deblock filter module 116. In the illustrated embodiment, the components of the video processing system 102 and the display system 104 are implemented on the same device, such as in the same integrated circuit (IC) package 118. However, in other embodiments, the video processing system 102 and the display system 104 may be implemented as separate devices. Moreover, although the video processing system 102 illustrates only a decoder 108, in other embodiments, the device also may implement an encoder, such as a codec (encoder-decoder) that serves to transcode encoded data.

The decoder 108 and the display controller 112 each may be implemented entirely in hard-coded logic (that is, hardware), as a combination of software 120 stored in a non-transitory computer readable storage medium (e.g., the memory 106) and one or more processors to access and execute the software, or as combination of hard-coded logic and software-executed functionality. To illustrate, in one embodiment, the media system 100 implements the IC package 118 whereby portions of the components 108 and 112 are implemented as hardware logic, and other portions are implemented via firmware (one embodiment of the software 120) stored at the IC package 118 and executed by one or more processors of the IC package 118. Such processors can include a central processing unit (CPU), a graphics processing unit (GPU), a microcontroller, a digital signal processor, a field programmable gate array, programmable logic device, state machine, logic circuitry, analog circuitry, digital circuitry, or any device that manipulates signals (analog and/or digital) based on operational instructions that are stored in the memory 106 or other non-transitory computer readable storage medium. To illustrate, the decoder 108 may be implemented as, for example, one or more CPUs or GPUs executing video decoding/compression/decompression software.

The non-transitory computer readable storage medium storing such software can include, for example, a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

As a general operational overview, the media system 100 receives encoded video data 124 representing an encoded video stream from any of a variety of multimedia sources, such as, for example, a file server or other video streaming service via the Internet or other type of network, an optical disc (e.g., DVD or Blu-Ray) player, a local file store, and the like. The decoder 108 operates to decode the encoded video data 124 to generate a series of pictures representing a video stream. Each picture in turn is temporarily stored via the memory controller 110 in a frame buffer 128 implemented in, for example, memory 106. At the appropriate time, the display controller 112 access the picture from the frame buffer 128 via the memory controller 110 and provides the picture for display at the display 114.

In at least one embodiment, the encoded video data 124 is encoded in accordance with the HEVC standard or in accordance with another tile-based coding standard, and thus the decoder 108 employs a complementary tile-based decoding process. As part of this decoding process, the decoder 108 utilizes the deblocking filter module 116 to provide deblock filtering of some or all of the pictures generated during the decoding process. As depicted in FIG. 1, the deblocking filter module 116 includes a deblocking filter kernel 130, a filter controller 132, and a buffer set 134. The buffer set 134 includes a top neighbor buffer 136, a left neighbor buffer 138, and a tile neighbor buffer 140. Further, in some embodiments, the buffer set 134 includes a tile buffer 142. The buffers 136-142 of the buffer set 134 may be implemented in the memory 106, in a separate “off-chip” memory, or in one or more storage components on the same package as the decoder 108, such as in one or more register files, or a combination thereof. To illustrate, the top neighbor buffer 136, left neighbor buffer 138, and the tile neighbor buffer 140 may be implemented as buffer regions within the memory 106. Further, the tile buffer 142 may be implemented as a buffer region separate from the frame buffer 128, or the tile buffer 142 instead may simply be the portion of the frame buffer 128 that stores the region of the picture corresponding to the tile being filtered.

In operation, each picture 141 generated by the decoder 108 was previously partitioned by a corresponding encoder into an array of tiles. The decoder 108 identifies this array of tiles, and each tile is then subjected to deblock filtering in raster scan order by the deblock filter module 116 to generate a filtered tile, with the resulting array of filtered tiles being stored as a deblocked picture 143 to the frame buffer 128 or other storage location. As described in greater detail below, except for the tile in the top-left corner of the picture, when the deblock filter processes each tile the deblocking filter module 116 uses pixel data from one or more of: the left-adjacent tile (defined as the tile in the tile array that is directly to the left of the tile being processed in the tile array); the top-adjacent tile (defined as the tile in the tile array that is directly above the tile being processed); and the left-diagonal tile (defined as the tile in the array that is directly to the upper left diagonal of the tile being processed), depending on the position of the tile being processed within the tile array. For ease of reference, the pixel data buffered from one or more of these neighboring tiles are collectively referred to herein as “neighbor pixel data.” To this end, the filter controller 132 interfaces with the memory controller 110 to arrange for transfer or copying of the relevant pixel data from the one or more neighboring tiles to the appropriate one of the buffers 136, 138, and 140. The filter kernel 130 then applies one or more deblock filtering processes to this pixel data using the neighbor pixel data buffered in one or more of the buffers 136-142 to generate filtered pixel data, which is then stored to the appropriate location in the frame buffer 128 as part of the deblocked picture 143. The deblock filtering process of a tile may include further modification to some or all of the neighbor pixel data (that is, deblock filtering at tile boundaries may modify both the tile being processed as well as the tiles adjacent to the tile being processed), in which case the filter controller 132 may coordinate with the memory controller 110 to overwrite the original neighbor pixel data as found in the frame buffer 128 with the corresponding modified neighbor pixel data when the modified neighbor pixel data is evicted from the corresponding buffer.

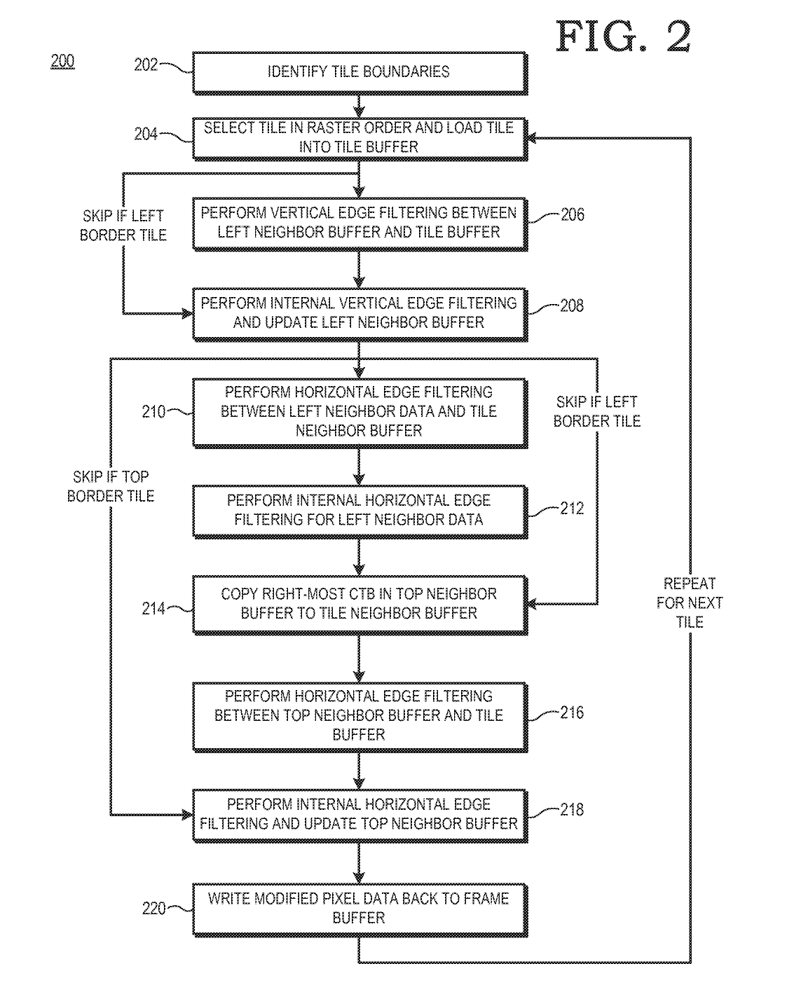

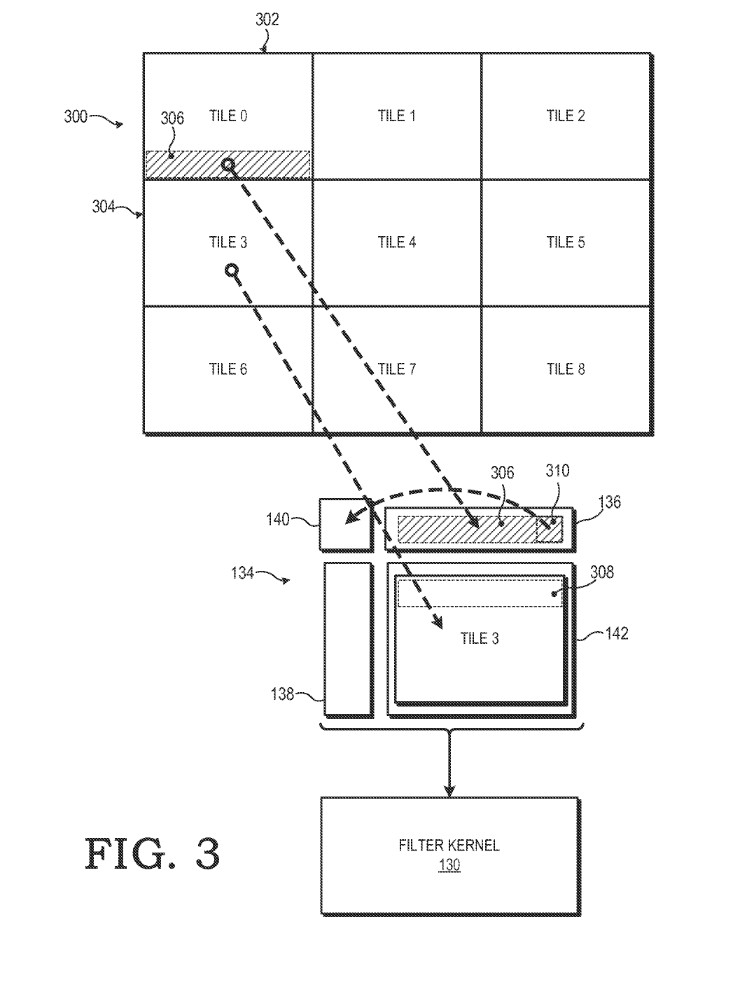

FIG. 2 illustrates an example method 200 of operation of the deblocking filter module 116 for deblock filtering a picture in accordance with at least one embodiment. FIGS. 3-6 depict various stages of the method 200 with respect to an example tile array 300 of the picture 141, and are referenced as in the description of the corresponding process blocks of the method 200 for illustrative purposes.

At step 202, the decoder 108 processes the encoded video data 124 to identify the tile boundaries of the decoded picture 141. For purposes of this example, the picture 141 is illustrated as a 3×3 array 300 (FIG. 3) of tiles, enumerated Tile 0-Tile 8. However, it will be appreciated that the number of tiles in the resulting array typically depends on the particular implementation, and it could be considerably larger than the number of tiles used in this example. For example, level 6 of the HEVC standard provides for arrays of up to 20 columns and 22 rows of tiles. Further, for ease of reference, the decoding process is described in the context of a decoding process performed in accordance with the HEVC standard. Thus, in this implementation, for each component (Y, Cb, Cr) each tile represents an array of CTBs, where each CTB typically is sized as a 16×16, 32×32, or 64×64 region of pixels. Note that while FIG. 3 depicts the tiles of the array as being of equal size, while the tiles in a row must be of the same height, tiles in different rows may be of different heights. Similarly, while the tiles in a column must be of the same width, tiles in different columns may be of different widths.

At step 204, the filter controller 132 selects a tile from the array 300 for filtering and loads the pixel data for the selected tile into the tile buffer 142. Typically, the tiles are selected and processed in the array 300 in raster order, and thus the tile at the top left corner of the array 300 is selected first, followed by the tile to its immediate right, and so forth. Note that the tile at the top left corner of the array 300 has neither a tile above it nor a tile to its left, and thus, as described in greater detail below, only internal edge filtering (hereinafter, “internal filtering”) is performed for the tile at the top left corner of the array 300. As part of the selection process, the filter controller 132 determines the position of the selected tile relative to the top border 302 and left border 304 (FIG. 3) of the array 300. Those tiles at the top border 302 are referred to herein as “top border tiles,” those tiles at the left border 304 are referred to herein as “left border tiles,” and those tiles having at least one tile between them and the top border 302 and left border 304 are referred to herein as “internal tiles.” As described below, various processes of method 200 may be skipped depending on whether the tile selected at step 204 is a top border tile, a left border tile, or an internal tile.

The deblock filtering process uses data from neighboring tiles. The bottom CTB row of the top-adjacent tile is stored in the top neighbor buffer 136. The right-most CTB column of the left-adjacent tile is stored in the left neighbor buffer 138. A top border tile does not have a top-adjacent tile, thus the top neighbor buffer contains null data at the start of processing a top border tile. Similarly, a left border tile does not have a left-adjacent tile, thus the left neighbor buffer contains null data at the start of processing a left border tile. The top neighbor buffer 136 is sized so as to store a row of CTBs or other set of rows of pixels across the entire width of the picture 141, and the left neighbor buffer 138 stores a column of CTBs or other set of columns of pixels for the entire height of the picture 141. The filter kernel 130 only uses the part in the top neighbor buffer and the part in the left neighbor buffer corresponding to the neighbor data for the tile it is processing.

The HEVC standard specifies that vertical edge filtering is to precede horizontal edge filtering. If the selected tile is an internal tile, then a left-diagonal tile to the selected tile was processed in a previous iteration of method 200, and thus the right-most CTB of the bottom CTB row of the left-diagonal tile of the selected tile was loaded into the tile neighbor buffer 140 during this previous iteration (as described below with reference to step 214). Thus, if the selected tile is not a left border tile, at step 206 the filter kernel 130 performs vertical edge filtering between the CTB column stored in the left neighbor buffer 138 and the left-most CTB column in the tile buffer 142. The modified left neighbor data is passed to a horizontal edge deblocking filter in the filter kernel 130. In the event that the selected tile is a left border tile, step 206 is skipped. To complete vertical edge filtering, at step 208 the filter kernel 130 performs filtering for the internal vertical edges of the selected tile (that is, filtering of the vertical edges that do not coincide with tile boundaries). Note the processes of steps 206 and 208 may be performed in parallel, as long as the correct order of filtering the edges is followed. At the end of step 208, the left neighbor buffer is updated to store the right-most CTB column of the selected tile.

With vertical edge filtering completed for the selected tile, the filter kernel 130 proceeds to horizontal edge filtering. For internal tiles, this includes the filter kernel 130 performing horizontal edge filtering between the left neighbor data (that already underwent vertical edge filtering) and the tile neighbor buffer 140 at step 210. Further, internal horizontal edge filtering is performed on the left neighbor data at step 212. Before proceeding to further deblock filtering, the filter controller 132 writes the modified pixel data in the tile neighbor buffer 140 (that is the CTB filtered at step 210) to its appropriate location in the frame buffer 128 and then overwrites this pixel data by directly copying the right-most CTB in the top neighbor buffer 136 to the tile neighbor buffer 140 unless the selected tile is a top border tile. After this copy process at step 214 is completed, the top neighbor buffer 136 is available for use for the subsequent horizontal edge filtering. At step 216, the filter kernel performs horizontal edge filtering between the top neighbor buffer 136 and the top CTB row in the tile buffer 142. In the event that the selected tile is a left border tile, steps 210 and 212 are skipped. In the event that the selected tile is a top border tile, steps 210 to 216 are skipped. Further, note the processes of steps 210 and 212 may be performed in parallel, as long as the correct order of filtering the edges is followed.

The filter kernel 130 then proceeds to internal deblock filtering of the horizontal edges of the selected tile at step 218 (that is, filtering of the horizontal edges that do not coincide with tile boundaries). At the end of step 218, the bottom-most CTB row of the selected tile is stored in the top neighbor buffer. After completing deblock filtering of the selected tile, the filtered pixel data of the buffers 136, 138, and 142 can be written to the appropriate locations of the frame buffer 128 at step 220.

FIG. 3 illustrates an iteration of the method 200 for processing Tile 3 (that is, after Tiles 0-2 have been processed in previous iterations of method 200). Accordingly, as illustrated by FIG. 3, the pixel data for Tile 3 is loaded into the tile buffer 142 and the bottom CTB row 306 of Tile 0 (as the top-adjacent tile to Tile 3) is in the top neighbor buffer 136 (stored during step 218 of iteration of method 200 for Tile 0). As Tile 3 is a left border tile, vertical edge filtering is only performed for the internal vertical edges. Prior to performing horizontal edge filtering, the right-most CTB 310 in the top neighbor buffer 136 is copied to the tile neighbor buffer 140 (step 214). The filter kernel 130 then may proceed to perform horizontal edge filtering between the bottom CTB row 306 of Tile 0 in the top neighbor buffer 136 and the top CTB row 308 of Tile 3 (step 216), and internal horizontal edge filtering of the pixel data in the tile buffer 142 (step 218) and then writing the resulting modified pixel data back to the frame buffer 128 (step 220).

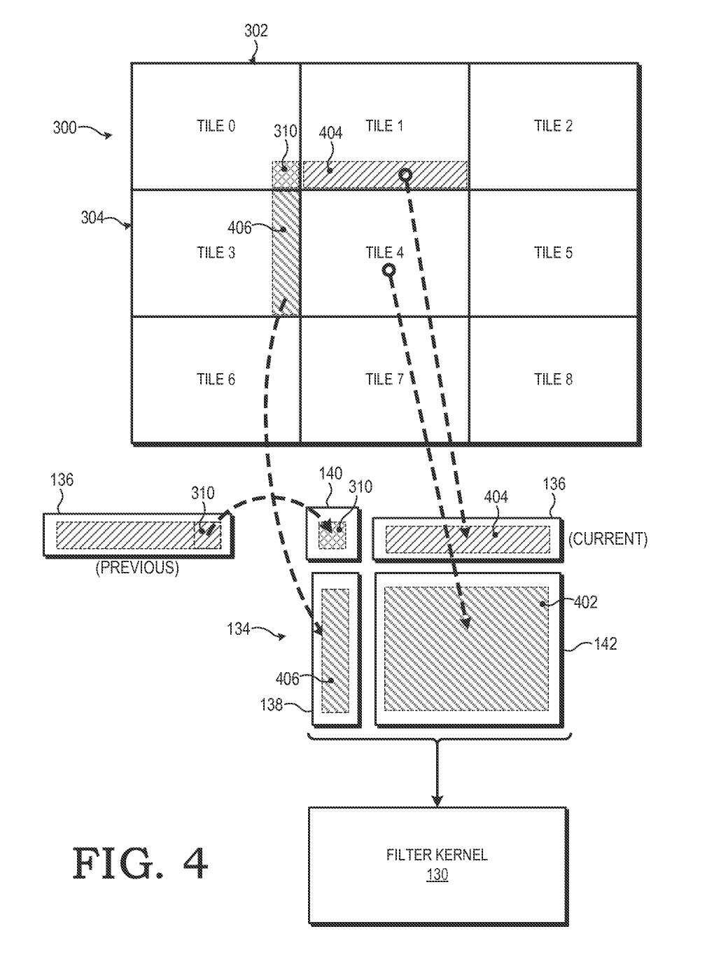

FIG. 4 illustrates the next iteration of the method 200 for processing Tile 4 following the processing of Tile 3. The CTB array 402 for Tile 4 is loaded into the tile buffer 142 (step 204). The bottom CTB row 404 of Tile 1, as the top-adjacent tile to Tile 4, has been stored in the top neighbor buffer 136 (step 218 of previous iteration of method 200 for Tile 1) and the right-most CTB column 406 of Tile 3, as the left-adjacent tile to Tile 4, has been stored in the left neighbor buffer 138 (step 208 of previous iteration of method 200 for Tile 3). As noted, the right-most CTB 310 in the top neighbor buffer 136 was copied into the tile neighbor buffer 140 during the previous processing of Tile 3. Thus, it will be appreciated that the right-most CTB 310 represents the bottom right corner of the left-adjacent tile (Tile 0) to Tile 4.

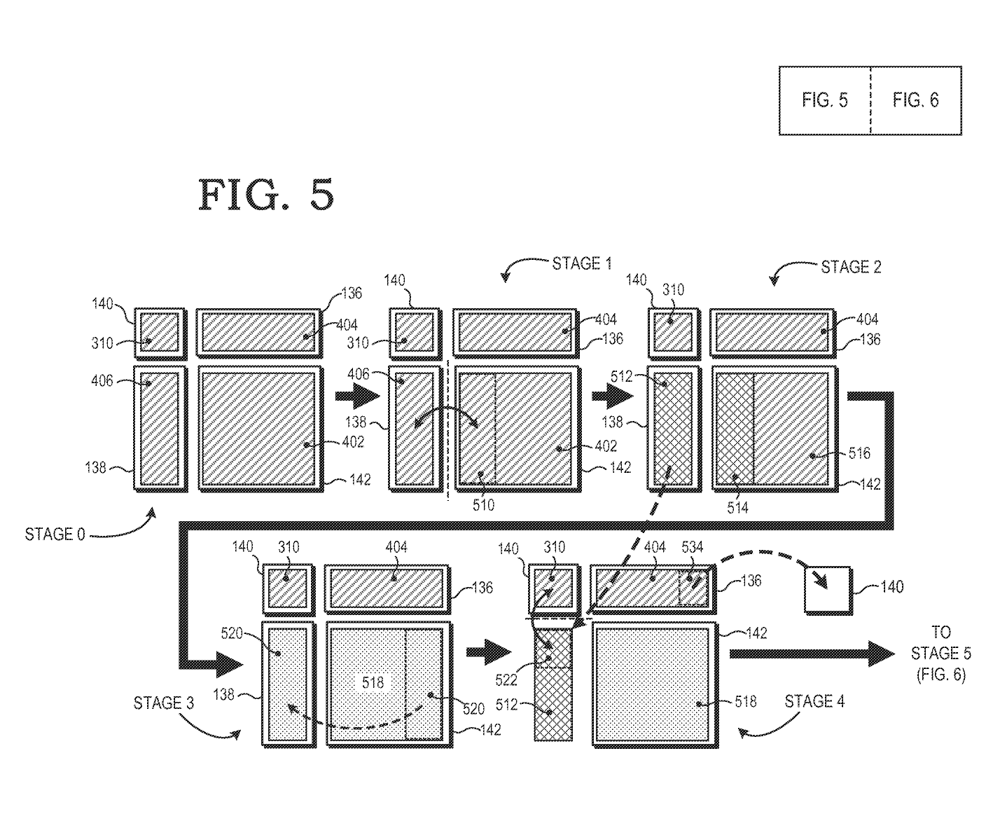

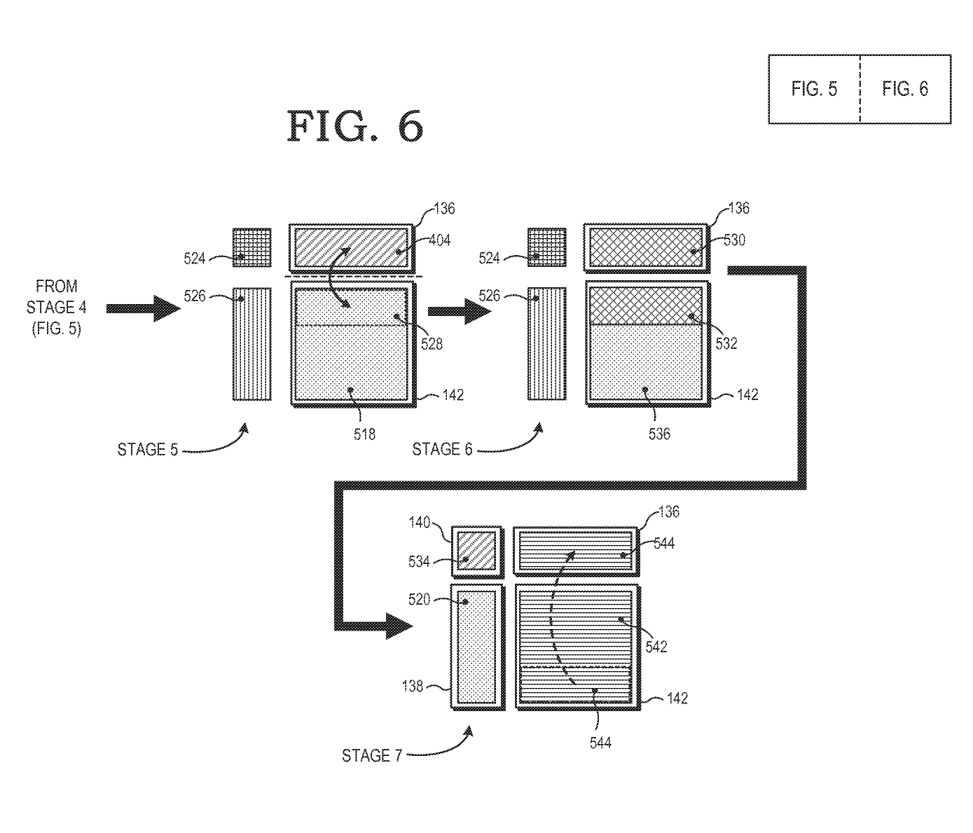

FIGS. 5 and 6 illustrate the horizontal and vertical edge filtering performed for processing Tile 4. At the illustrated stage 0 the CTB array 402 from Tile 4 is loaded into tile buffer 142, the bottom CTB row 404 from Tile 1 is stored in the top neighbor buffer 136, and the CTB column 406 at the right edge of Tile 3 is stored in the left neighbor buffer 138. Note that only the relevant portion of the top neighbor buffer and the left neighbor buffer are shown in the figure, as those neighbor buffers also store data that is used for processing other tiles. Further, because Tile 3 was processed before Tile 4, the CTB 310 at the bottom right corner of Tile 0 was previously copied to the tile neighbor buffer 140 from the top neighbor buffer 136 during the initial deblock filtering of Tile 3. With the buffers 136-142 loaded with this pixel data, at stage 1 the CTB column 406 in the left neighbor buffer 138 and the left-most CTB column 510 in Tile 4 are filtered together (step 206), thereby modifying the CTB column 406 and the CTB column 510 to produce modified CTB columns 512 and 514, respectively, in the illustrated stage 2. As the CTB array 402 of Tile 4 has been modified, it is referred to as modified CTB array 516. Vertical edge filtering is completed for CTB column 512, thus it is passed on to a later stage for horizontal edge filter. At stage 3 the deblocking filter module 116 performs internal vertical edge filtering on CTB array 516 to produce further modified CTB array 518 (step 208). At the end of step 208, the right-most CTB column 520 of CTB array 518 is stored in the left neighbor buffer 138 so it is ready for use when processing Tile 5 in the next iteration of method 200.

Following completion of the vertical edge filtering, at stage 4 the deblocking filter module 116 initiates horizontal edge filtering for the horizontal edges between Tiles 0, 1, 3, and 4. Accordingly, CTB block 310 in the tile neighbor buffer 140 and the top CTB block 522 in the left neighbor CTB column 512 (passed on from the vertical edge filtering stage) are filtered together (step 210), followed by internal horizontal edge filtering of the modified left neighbor CTB column 512 (step 212), to produce modified CTB block 524 and CTB column 526, respectively, in the illustrated stage 5. Prior to performing further horizontal edge filtering, the modified CTB 524 is written to frame buffer 128 and the right-most CTB 534 of the CTB row 404 is copied from the top neighbor buffer 136 to the tile neighbor buffer 140 (step 214). This results in the tile neighbor buffer 140 being loaded with the bottom right corner of Tile 1 and thus ready for tile boundary filtering of Tile 5 when it is selected during the next iteration of method 200. Moreover, the copying of the right-most CTB in the top neighbor buffer 136 to the tile neighbor buffer 140 at this point frees the top neighbor buffer 136 for use during the subsequent filtering process (steps 216 and 218).

After the copying is done, the CTB row 404 in the top neighbor buffer 136 and the top CTB row 528 of the modified CTB array 518 are filtered together (step 216), which modifies the CTB row 404 and the top CTB row 528 to produce modified CTB row 530 and modified CTB row 532, respectively, in the illustrated stage 6. As the modified CTB array 518 has been further modified in this process, it is referred to as modified CTB array 536. Further, the filter module 116 performs internal horizontal edge filtering for CTB array 536 (step 218), which produces CTB array 542 in the illustrated stage 7. At the end of step 218, the bottom-most CTB row 544 of CTB array 542 is stored in the top neighbor buffer 136 so it is ready for use when processing Tile 7 in a subsequent iteration of method 200. The filtered pixel data in CTB block 524, CTB column 526, CTB row 530 and tile buffer 142 are written to frame buffer 128 (step 220).

With the introduction of tiles in a picture, the previous method of neighbor data buffering using a top neighbor buffer and a left neighbor buffer is insufficient to store all the neighbor data required by the deblocking filter. The addition of a tile neighbor buffer preserves the required neighbor data that would have otherwise be overwritten in the top neighbor buffer. By utilizing a direct transfer of a subset of pixel data from the top neighbor buffer 136 as obtained during processing of the previous tile to the tile neighbor buffer 140 for filtering when the current tile is processed, the pixel data representing the bottom corner of the upper-left-adjacent tile is readily available for processing the next tile. Moreover, as the number of pixels to be stored in the tile neighbor buffer 140, and thus the necessary minimum size of the tile neighbor buffer 140, depends only on the number of taps in the filter kernel 130, the tile neighbor buffer 140 is independent of the size of the picture 141 or the number of tiles in the tile array. As such, the tile neighbor buffer 140 may be implemented as a compact buffer with minimal storage resources. Moreover, the tile neighbor buffer 140 does not need to be re-sized if picture size, tile size, or tile number requirements change.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method for deblock filtering of a picture at a video processing system to generate a deblocked picture, the method comprising:
identifying an array of tiles in the picture; and
for each tile not adjacent to a top border or a left border of the picture:
transferring a subset of first pixel data from a first buffer to a second buffer, the first pixel data representing a set of one or more bottom rows of pixels of a left-diagonal tile and the subset of pixel data representing pixel data for pixels at a bottom right corner of the left-diagonal tile;
after transferring the subset of the first pixel data, buffering second pixel data representing a set of one or more bottom rows of pixels of a left-adjacent tile in the first buffer, the second pixel data overwriting the first pixel data;
buffering third pixel data representing a set of one or more bottom rows of pixels of a top-adjacent tile in another part of the first buffer;
buffering fourth pixel data representing one or more columns of pixels from a left-adjacent tile in a third buffer; and
deblock filtering at boundaries of the tile using pixel data in the first, second, and third buffers.

2. The method of claim 1, wherein deblock filtering comprises:
vertical edge filtering between the third buffer and a set of one or more columns of pixels at a left border of the tile.

3. The method of claim 2, wherein deblock filtering further comprises:
horizontal edge filtering between the second buffer and the third buffer and between the first buffer and a set of one or more rows of pixels at a top border of the tile.

4. The method of claim 3, wherein the horizontal edge filtering is performed after the vertical edge filtering.

5. The method of claim 1, wherein deblock filtering the tile comprises deblock filtering the tile using a deblock filter process compliant with a High Efficiency Video Coding (HEVC) standard.

6. The method of claim 1, wherein:
a size of the second buffer is independent of a picture size of the picture and a tile size of the tiles of the array.

7. A non-transitory computer readable storage medium storing instructions that manipulate at least one processor to perform the method of claim 1.

8. A method for deblock filtering of a picture at a video processing system to generate a deblocked picture, the method comprising:
identifying an array of tiles representing the picture;
buffering first pixel data in a first buffer, the first pixel data representing a set of one or more bottom rows of a partially deblock filtered first tile;
copying a subset of pixel data in the first buffer to a second buffer, the subset of pixel data representing pixels at a bottom right corner of the partially deblock filtered first tile;
after copying the subset of pixel data, deblock filtering pixel data internal to a second tile using the first buffer, the first tile being a top-adjacent tile to the second tile;
after deblock filtering pixel data internal to the second tile, buffering third pixel data at the first buffer, the third pixel data representing a set of one or more bottom rows of a third tile, the first tile being a left-adjacent tile to the third tile and a left-diagonal tile to a fourth tile;
buffering fourth pixel data in a third buffer, the fourth pixel data representing a set of one or more columns of the partially deblock filtered second tile; and
deblock filtering at boundaries of the fourth tile using the first, second, and third buffers.

9. The method of claim 8, further comprising:
copying a subset of pixel data in the first buffer to the second buffer, the subset of pixel data representing pixels at a bottom right corner of the partially deblock filtered third tile;
after copying the subset of pixel data, deblock filtering pixel data internal to the fourth tile using the first buffer;
after deblock filtering pixel data internal to the fourth tile, buffering fifth pixel data at the first buffer, the fifth pixel data representing a set of one or more bottom rows of a fifth tile, the fifth tile being a top-adjacent tile to a sixth tile;
buffering sixth pixel data in the third buffer, the sixth pixel data representing a set of one or more columns of the partially deblock filtered fourth tile; and
deblock filtering at boundaries of the sixth tile using the first, second, and third buffers.

10. The method of claim 8, wherein deblock filtering at the boundaries of the fourth tile comprises:
vertical edge filtering between the third buffer and a set of one or more columns of pixels at a left border of the fourth tile.

11. The method of claim 10, wherein deblock filtering at the boundaries of the fourth tile further comprises:
horizontal edge filtering between the second buffer and the third buffer and between the first buffer and a set of one or more rows of pixels at a top border of the fourth tile after the vertical edge filtering.

12. The method of claim 8, wherein deblock filtering the fourth tile comprises deblock filtering the fourth tile using a deblock filter process compliant with a High Efficiency Video Coding (HEVC) standard.

13. The method of claim 8, wherein:
a size of the second buffer is independent of a picture size of the picture and a tile size of the tiles of the array.

14. A non-transitory computer readable storage medium storing instructions that manipulate at least one processor to perform the method of claim 8.

15. A video processing system comprising:
a decoder to identify an array of tiles representing a picture; and
a deblock filter module to deblock filter the picture to generate a deblocked picture, the deblock filter module comprising:
a buffer set comprising a first buffer, a second buffer, and a third buffer;
a filter controller to, for each tile not adjacent to a top border or a left border of the picture:
transfer a subset of first pixel data from a first buffer to a second buffer, the first pixel data representing a set of one or more bottom rows of pixels of a left-diagonal tile and the subset of pixel data representing pixel data for pixels at the bottom right corner of the left-diagonal tile;
after transferring the subset of the first pixel data, buffer second pixel data representing a set of one or more bottom rows of pixels of a left-adjacent tile in the first buffer, the second pixel data overwriting the first pixel data; and
buffer third pixel data representing a set of one or more bottom rows of pixels of a top-adjacent tile in another part of the first buffer;
buffer fourth pixel data representing one or more columns of pixels from a left-adjacent tile in a third buffer; and
a filter kernel to deblock filter at boundaries of the tile using pixel data in the first, second, and third buffers.

16. The video processing system of claim 15, wherein the filter kernel is to deblock filter at boundaries of the tile by:
vertical edge filtering between the third buffer and a set of one or more columns of pixels at a left border of the tile.

17. The video processing system of claim 16, wherein the filter kernel is to deblock filter at boundaries of the tile further by:
horizontal edge filtering between the second buffer and the third buffer and between the first buffer and a set of one or more rows of pixels at a top border of the tile.

18. The video processing system of claim 17, wherein the filter kernel is to perform the horizontal edge filtering after performing the vertical edge filtering.

19. The video processing system of claim 15, wherein the filter kernel implements a deblock filter process compliant with a High Efficiency Video Coding (HEVC) standard.

20. The video processing system of claim 15, wherein:
a size of the second buffer is independent of a picture size of the picture or a tile size of the tiles of the array.
